(19) United States
(12) Patent Application Publication
(10) Pub. No.: US 2025/0362687 A1
(43) Pub. Date: Nov. 27, 2025

(54) Method for an Optimized Motion Planning of a Robot Device

(71) Applicant: ABB Schweiz AG, Baden (CH)

(72) Inventors: Arne Wahrburg, Weiterstadt (DE); Nima Enayati, Mannheim (DE); Rene Kirsten, Fernwald (DE); Mikael Norrlöf, Norrköping (SE); Giacomo Spampinato, Västerås (SE); Debora Clever, Zwingenberg (DE); Florian Stuhlenmiller, Ladenburg (DE); Morten Akerblad, Västerås (SE); Mattias Björkman, Västerås (SE)

(73) Assignee: ABB Schweiz AG, Baden (CH)

(21) Appl. No.: 19/288,093

(22) Filed: Aug. 1, 2025

Related U.S. Application Data
(63) Continuation of application No. PCT/EP2023/052741, filed on Feb. 3, 2023.

(51) Int. Cl. G05D 1/644; G05D 101/15; G05D 109/10

(52) U.S. Cl. CPC G05D 1/644; G05D 2101/15; G05D 2109/10

(57) ABSTRACT

A method includes generating a first trajectory based on a query parameter using a conventional motion planner that plans a geometric path in a first step and optimizes an evolution in a second step to generate the first trajectory; generating a second trajectory using a learning-based motion planner; applying a post process to validate an optimized second trajectory based on the second trajectory; comparing the first trajectory with the optimized second trajectory and selecting the trajectory that meets the at least one performance criterion; and performing a background process improving the learning-based motion planner by feeding an optimal motion planner that integrates path and trajectory generation with the at least one query parameter to generate training data; and training the first learning-based motion planner using the training data, wherein at least one parameter of the first learning-based motion planner is input for the second learning-based motion planner.

### CROSS-REFERENCE TO RELATED APPLICATIONS

The instant application claims priority to International Patent Application No. PCT/EP2023/052741, filed Feb. 3, 2023, which is incorporated herein in its entirety by reference.

### FIELD OF THE DISCLOSURE

The present disclosure generally relates to a method for an optimized motion planning of at least one robot device.

### BACKGROUND OF THE INVENTION

Existing motion planning systems can be categorized into three types-conventional two-step planning, integrated path and trajectory optimizers and learning-based approaches. With the conventional approach, a geometric path is generated, and then an evolution over time on the given geometry is defined. The disadvantage of this approach is, however, that the fixed geometry results in a sub-optimal performance in terms of cycle-time and energy consumption. When using integrated path and trajectory optimizers, also known as optimal motion planners, both path and time evolution are generated through an optimization process. However, using this approach alone is computationally demanding and the generation of motion plans cannot be done in online applications and in a real-time production environment. The learning-based motion planners include artificial neural networks predicting or approximating an optimal trajectory based on given start and end point. Although this third approach provides solutions in a fast manner, a large amount of training data needs to be provided to train the learned planners which makes using this approach alone not very practicable for applications in a run-time or online production scenario.

### BRIEF SUMMARY OF THE INVENTION

The present disclosure describes systems and methods for an improved concept of an optimized motion planning of at least one robot device.

In a first aspect, there is provided a method for an optimized motion planning of at least one robot device, the method comprising: generating a first trajectory for the at least one robot device based on at least one query parameter by using a conventional motion planner that is configured to plan a geometric path in a first step and optimize an evolution over time on the geometric path in a second step in order generate the first trajectory; generating a second trajectory by using a learning-based motion planner; applying a post-process to validate an optimized second trajectory based on the second trajectory; comparing the first trajectory with the optimized second trajectory based on at least one performance criterion and selecting the trajectory which better meets the at least one performance criterion; and performing a background process improving the learning-based motion planner, comprising the steps of feeding an optimal motion planner that integrates path and trajectory generation with the at least one query parameter in order to generate training data; training of the first learning-based motion planner by using the training data, wherein at least one parameter of the first learning-based motion planner is used as an input parameter for the second learning-based motion planner.

In other words, the present disclosure describes a combination of three motion planning systems: a conventional motion planner, an optimal motion planner (=integrated path and trajectory optimizer), and a learning-based motion planner in a certain manner.

The major advantages achieved by this approach are that the motion planning system of the present invention can be used without large delays at a decent performance level and that the motion performance will improve over time.

Further advantages that can be achieved by the present invention. For example, highly-optimized motion of the robot device with fixed time budget, Improved motion performance of the robot device in applications of item picking, Different quality or performance criteria when using the robot device in production can be easily and efficiently optimized and adapted to changing production scenarios or applications, e.g. motion speed of the robot device, motion time, energy consumption during specific motions or over the robot lifetime, robot device lifetime. However, the present invention is not restricted to these examples of performance criteria.

These advantages can be achieved by using the conventional motion planner in the beginning to plan the motion or trajectory for the robot device for received queries which can be implemented in one or more query parameters. A query parameter may comprise for instance a start and a target point or region for the robot device. In parallel to the normal operation of generating a trajectory for the at least one robot device, a training operation—by using the background process or task which is performed in parallel or in an asynchronous way to the normal operation—takes place on separate threads or hardware than the ones dedicated to the normal operation.

### BRIEF DESCRIPTION OF THE SEVERAL VIEWS OF THE DRAWING(S)

FIG. 1 is a flowchart of a method in accordance with the present disclosure.

FIG. 2 is a flowchart of a method in accordance with the present disclosure.

FIG. 3 is a schematic of a first implementation of the present disclosure.

FIG. 4 is a schematic of a second implementation of the present disclosure.

FIG. 5 is a schematic implementation of a background process of the present disclosure.

### DETAILED DESCRIPTION OF THE INVENTION

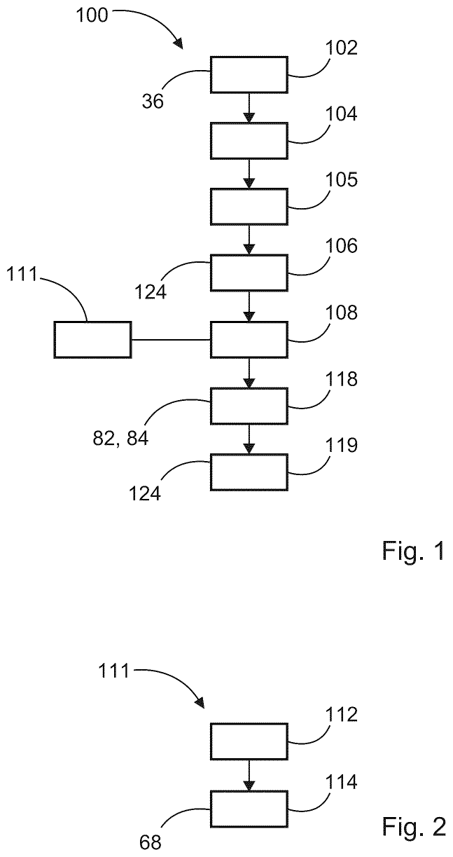

FIG. 1 illustrates a schematic flow-diagram of a method 100 for an optimized motion planning of at least one robot device 10 of the present invention. In a first step 102, a first trajectory 30 for the at least one robot device 10 is generated based on at least one query parameter 36 by using a conventional motion planner 40 that is configured to plan a geometric path in a first step and optimize an evolution over time on the geometric path in a second step in order generate the first trajectory 30. The least one query parameter 36 may comprise a start and a target information for the at least one robot device 10, 20.

In a second step 104, a second trajectory 32 is generated by using a second learning-based motion planner 51. In a third step 105, a post-process 124 is applied to validate an optimized trajectory 34 based on the second trajectory 32. In a fourth step 106, the first trajectory 30 is compared with the optimized second trajectory 32 based on at least one performance criterion and further, performing the step of selecting 118 the trajectory 30, 34 which better meets the at least one performance criterion. The at least one performance criterion may be a motion speed or a defined energy consumption of the at least one robot device 10, 20.

In a fifth step 108, a background process 111 improving the first learning-based motion planner 50 is performed, comprising the steps: feeding 112 an optimal motion planner 60 that integrates path and trajectory generation with the at least one query parameter 36 in order to generate training data 80; and training 114 of the first learning-based motion planner 50 by using the training data 80, wherein at least one parameter 68 of the first learning-based motion planner 50 is used as an input parameter for the second learning-based motion planner 51.

The first learning-based motion planner 50 is preferably embodied as an artificial neuronal network. Also, the second learning-based motion planner 51 may be embodied as an artificial neuronal network. In this respect, both learning-based motion planners 50, 51 should preferably have the same or similar structure, so it is possible to pass parameter from first learning-based motion planner 50 to the second learning-based motion planner 51.

In this context, it should be noted that during runtime of the at least one robot device 10, 20, only the step of generating 102 the first trajectory 30, the step of generating 104 a second trajectory 32 and the step of validating 118 and the step of comparing 106 are necessary.

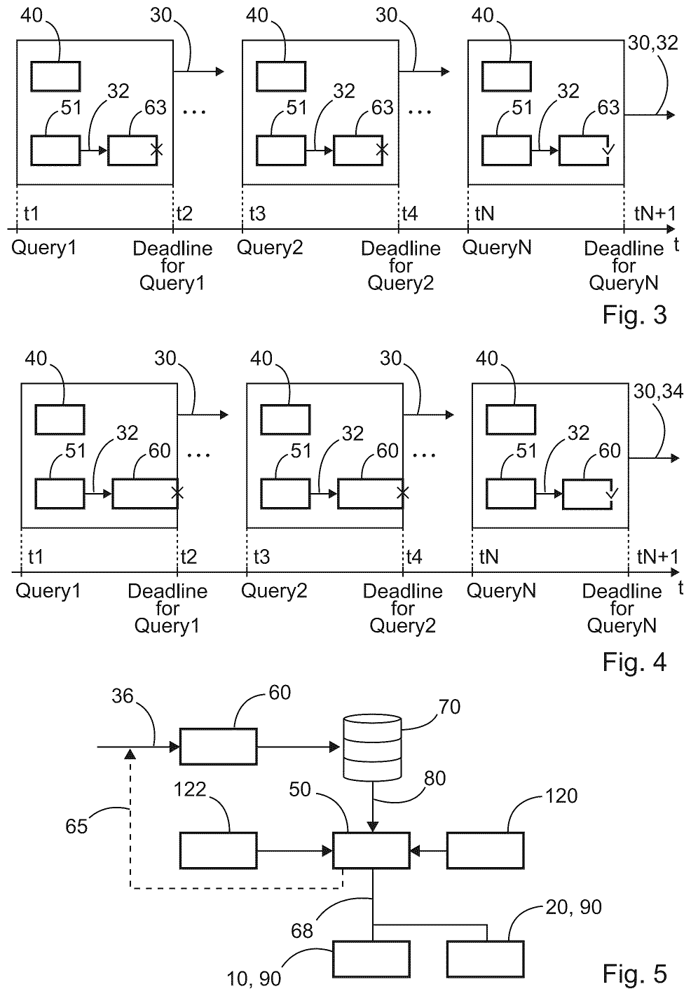

FIG. 2 illustrates a schematic flow-diagram of a method for a background process 111 of the present invention. The background process 111 comprises the steps of: feeding 112 an optimal motion planner 60 that integrates path and trajectory generation with the at least one query parameter 36 in order to generate training data 80, and training 114 of the first learning-based motion planner 50 by using the training data 80. The output of the first learning-based motion planner 50 is at least one parameter 68 which is used as an input parameter for the second learning-based motion planner 51 (see FIG. 3).

FIG. 3 illustrates a schematic first implementation of the present invention and shows how the two types of motion planners-a conventional (two-step) motion planner 40 and a second learning-based motion planner 51 are be combined in an efficient way to retain the advantages of each planner type and to achieve an optimized motion planning for at least one robot device 10, 20.

However, it should be noted that in the validation step 119 performed by the validator 63, the optimal motion planner 60 needs not to be implemented. This is, because in the validation stage 119, there is no need to solve an optimization problem, but only to evaluate a cost function to assess the quality and the constraints to assess validity. Those two things are much cheaper from a computational perspective compared to solving an optimal motion planning problem.

The present invention is preferably applied to robot devices 10, 20 which perform repetitive tasks in the sense of the motions to be planned in each cycle being similar but not necessarily equal. Examples for such repetitive tasks may include item picking, pick-and-place, and palletization/de-palletization. As only relatively small parts of a robot workspace are regions of interest, the search space for the first learning-based motion planner 50 (see FIG. 5) is comparatively small, allowing it to produce acceptable results without requiring excessive amounts of training data. Further, it should be noted that the method 100 can be performed in runtime and during employment of the at least one robot device 10, 20.

Generally, a trajectory must be generated for each received query (e.g., start/end targets of the robot device 10, 20) before a certain deadline is reached or a certain time budget runs out, e.g. a timeout, when a result of a final trajectory must be finally provided to control or to provide control instructions to the robot device 10, 20.

A received query may be embodied as at least one query parameter 36 comprising a start and a target information for the at least one robot device 10, 20. The start and target information may be for example a start and target point or a start and a target region.

The conventional motion planner 40 generates a first 30 trajectory rapidly and well within an available time budget.

In the embodiment of FIG. 3, when starting with Query1 at time marker t1, the second learning-based motion planner 51 generates a second trajectory 32 as output which will be forwarded as an input to a validator 63 which performs the step of validating 119 as described before.

In this context, the parameters of the (artificial) neural network for the second learning-based motion planner 51 are updated by the at least one parameter 68 of the first learning-based motion planner 50. Hence, the parameter 68 is the result of the background task 111. The at least one parameter 68 of the first learning-based motion planner 50 is continuously optimized by said training data 80. In other words, the database 70 of FIG. 5 is filled by querying the optimal motion planner 60 repeatedly and represents the training data 80 that is used to continuously improve the parameters of the first learning-based planner 50.

The background task 111 of FIG. 5 uses the optimal motion planner 60 and provides an optimized solution for a parameter as output of the neural network 50 with a better quality. But doing so can take too long to compute the trajectory according to embodiment of FIG. 3. However, this is of no concern for the proposed solution as the optimal motion planner 60 of the background task 111 in FIG. 5 is run asynchronously or in parallel compared to the main process steps 102, 104, 105, 106 and that does not need to terminate before a defined time budget runs out.

Further, it should be noted that the task queries are fed to a sampler (not displayed in FIG. 5) which may be connected to the optimal motion planner 60 of the background process 111 to generate similar samples to improve coverage of the relevant workspace of the robot device 10, 20 and increase the amount of available data for training. The results of the background process 111 for each of these samples are then stored in a database 70 which is used in training of the first learning-based motion planner 50. When new data is added to the database 70, the training of the first learning-based motion planner 50 is triggered.

In the following, the first implementation of the present invention as shown in FIG. 3 is explained in detail according to the timeline t. The goal of the first implementation of the present invention according to FIG. 3 is to directly applying the result or at least one parameter 68 of the first learning-based motion planner 50 of the background task 111 to the second learning-based motion planner 51 to finally find or produce a second trajectory 32 that can be used at a defined deadline.

In time slot t1 of the timeline, a first query Query1 in form of a query parameter 36 is received which triggers the conventional motion planner 40 to generate a first trajectory 30. Accordingly, the second learning-based motion planner 51 is triggered to generate a second trajectory 32.

After step 104, the step 105 is performed applying a post process 124 to validate 119 the second trajectory 32.

In detail and according to the embodiment of FIG. 3, in the post-process 124, the second trajectory 32 is validated by comparing a first quality parameter 82 of the second trajectory 32 with a defined second quality parameter 84 and if the first quality parameter 82 fulfils the second quality parameter 84, the step 106 of comparing is performed. The at least second quality parameter 84 may define at least one criterion relating to a property of the at least one robot device 10, 20, e.g. position, speed, torque, collision-free path etc.

In regard of the validation stage 119 performed by the validator 63, the following is performed: The second trajectory 32 is only sent to the controller 90 (see FIG. 5) to control the at least one robot device 10, 20, when the following two conditions are validated: the second trajectory 32 respects all essential constraints, e.g., position, speed, torque, collision, etc. of the at least one robot device 10, 20, and the performance of the optimized second trajectory 32 of the second learning-based motion planner 51 is better than the performance or quality of first trajectory 30 provided by the conventional motion planner 40.

Referring to FIG. 3, according to step 106, the first trajectory 30 is compared with the second trajectory 32 based on at least one performance criterion and then, according to time marker Query N in FIG. 3, the trajectory 30, 32 is selected in step 118 which better meets the at least one performance criterion. This process is repeated multiple times, if necessary, starting with Query1, Query2 to QueryN.

In this context, it should be further stated that the output of the second learning-based motion planner 51 according to FIG. 3 fulfils two conditions: First and as a first condition, the output of the second learning-based motion planner 51 is a trajectory 32 that outperforms the first trajectory 30 of the conventional motion planner 40 in the sense of a defined performance criterion or a defined or specified optimization criterion, e.g. a cycle time, an energy consumption of the robot device 10, 20 etc.; Second and as a second condition, the second trajectory 32 generated by the second learning-based motion planner 51 has to satisfy all constraints that have been specified, e.g. joint angle limits, joint speed limits, joint torque limits etc., in order to be compatible with the robot device 10, 20 at hand. Hence, the first quality parameter 82 of the second trajectory 32 should fulfil these two conditions as stated above.

The background process 111 as indicated by FIG. 5, is performed in parallel or in an asynchronous manner to provide as a result at least one parameter 68 for the second learning-based motion planner 51 in FIG. 3, as explained in the following. In the background process 111, the optimal motion planner 60 is fed with at least one query parameter 36 involving a (random) query with a start and end position of the at least one robot device 10, 20. The result or output of the optimal motion planner 60 is then put into the database 70 to generate training data 80. This training data 80 is then used as input data for the learning-based motion planner 50 of the background process 111 (see FIG. 5), e.g. the artificial neuronal network, to optimize the at least one parameter of this artificial neuronal network. The optimized parameters of the artificial neuronal network are then used by the learning-based motion planner 50 in FIG. 3 to produce better trajectories or a better second trajectory 34 over time. It is important to emphasize that in the embodiment of FIG. 3, the second trajectory 32 is not directly optimized in or by the background task 111.

The background process 111—referring to FIG. 5—comprises the steps of feeding 112 an optimal motion planner 60 that integrates path and trajectory generation with the at least one query parameter 36 in order to generate training data 80; and training 114 of the first learning-based motion planner 50 by using the training data 80.

The selected trajectory 30 or 32 is then sent to the controller 90 (FIG. 5) of a at least one robot device 10, 20 to control the at least one robot device 10, 20. The decision which trajectory 30, 32 is selected is taken in time slot t2 of the timeline t, indicating a deadline for the first query. In stage 2, Query2 of FIG. 3, it is indicated that the quality of the first trajectory 30 is still better than the quality of the second trajectory 32.

Still referring to FIG. 3, in time slots t3 to t4 of the timeline and more general, until time slots t(n) to t(n+1), the process as described before is repeated for further queries 2, 3 . . . n for several times and as long as necessary until an acceptable or defined quality of a second trajectory 32 as output of the second learning-based motion planner 51 is achieved.

It this context, referring to FIG. 3, it should be further noted that in the early stages of method 100, the trajectory produced by the second learning-based motion planner 51 will most likely be invalid and/or worse compared to the conventional motion planner 40, indicated by the crosses in FIG. 3. But as more and more solutions of the optimal motion planner 60 are produced in the asynchronous background task 111, the database 70 of solutions grows, allowing the training task to improve the output parameter of the first learning-based motion planner 50. Hence, the chances of the trajectory 32 outputted by the second trained learning-based motion planner 51 of FIG. 3 for passing the validation stage 119 increase—indicated with a checkmark in FIG. 3. As both querying the second learning-based motion planner 51 and the validation stage 119 are computationally efficient, overall planning can be completed within the allotted time budget.

FIG. 4 illustrates a schematic second implementation of the present invention using the three types of planners 40, 50 and 60 in a way, as it is described in the following. In general, this second implementation uses the output of the second learning-based motion planner 51 for a warm-start of the optimal motion planner 60. The second implementation also relies on first querying the conventional two-step motion planner 40 and as well as using the first learning-based motion planner 50 of FIG. 5.

However, instead of directly using the output of the first learning-based motion planner 50 as shown in FIG. 3, the output is now considered as an intermediate trajectory that is employed to provide initial guesses or start points for the optimal motion planner 60. If the quality of the solution produced by the second learning-based motion planner 51 is sufficiently high (and constraints are satisfied), such a warm starting can considerably reduce the computation time of the optimal motion planner 60. As indicated in FIG. 4, the overall planning time can potentially be reduced such that the available time budget is not exceeded.

In this way, and referring to FIG. 5, the output 65 of the trained first learning-based motion planner 50 is used as an initial solution for the optimal motion planner 60 in the background process 111.

Like the first implementation according to FIG. 3, the possibility of optimal motion planner 60 converging on time is very low in the early stages of program execution. But as the quality of the second learning-based motion planner 51 in FIG. 4 improves over time, the computation time of the optimal motion planner 60 is more likely to be reduced due to improved initial guesses—indicated by a green checkmark in FIG. 4.

If the optimal motion planner 60 fails to converge to a valid solution with a better performance quality than the motion plan solution provided by the conventional motion planner 30, the method falls back to that original plan—indicated by the crosses in time slots t2, t4 of the timeline t of FIG. 4 and the first trajectory 30 is selected. However, in the last stage of FIG. 4, indicated by QueryN, the second trajectory 32 output by the second learning-based motion planner 51 is taken as an input for the optimal motion planner 60 again to generate an optimized second trajectory 34. When the optimized second trajectory 34 has a better quality than the first trajectory 30, the optimized second trajectory 34 is finally selected to control the at least one robot device 10, 20.

Hence, the solution is lower bounded by the conventional two-step motion planning approach. It is further noted that, for the second implementation according to FIG. 4, no dedicated validation stage is required in this approach as constraint satisfaction and computation of the cost function are inherent parts of the optimal motion planner 60. In the embodiment of FIG. 4, no checking of constraint fulfilment is required. However, the step of comparing 116 is still needed.

FIG. 5 illustrates a schematic implementation of the background process or background task 111 of the present disclosure. At the beginning, at least one query parameter 36, which can be any sort of a query request or a query value or multiple query values, is provided to the optimal motion planner 60 which may be followed after a sampler (not displayed in FIG. 5). The queries are fed to the sampler to generate similar samples to improve coverage of the relevant workspace and increase the amount of available data for the training of the first learning-based motion planner 50. The samples or the query parameter 36 are optimized by the optimal motion planner 60. The results of the optimal motion planner 60 are then stored in a database 70 which are used as training data 80 for the first learning-based motion planner 50. Any time, when new training data is added to the database 70, the training of the earning-based motion planner 50 is triggered.

Further, the embodiment of FIG. 5 shows two additional or optional functionalities which can be provided when using the background task as described before.

One option is that the background task allows offline pre-training 122 as indicated in FIG. 5. This means that the optimal motion planner 60 can be provided with query parameters or queries multiple times in an offline simulator. The data generated in that process is employed to pre-train the first learning-based motion planner 50. By shuffling data generation and training time to the offline world, less cycles are needed on the real-world setup to produce productivity enhancements.

A further option when using the background task of the present invention, is that the results of a transfer learning 120 can be applied to leverage prior experience as indicated in FIG. 5. To this end, the trained neural network from some other cell or robot device 20 is used to warm-start the training parameters of the first learning-based motion planner 50 for the robot device 10 at hand. If the robot devices 10, 20 have similar kinematic and dynamic properties and the queries (start/end targets and payload properties) are sufficiently similar, this transfer of knowledge can notably reduce training time for the learned planner.

In the general context of the present disclosure, the main functionality of the dedicated background task according to the present invention can be described as following: When a new query is received, several queries are sampled in its neighborhood, and these generated queries are sent to the optimal motion planner. The sampled queries and their corresponding generated trajectories from the optimal motion planner are then stored in a database. These results in the database are then used to train the learning-based motion planner which can be a neural network mapping the start and end points to a motion plan which are path and trajectories for the robot device. As more training data becomes available, the learning-based motion planner approximates the optimal motion planner better and eventually will be able to reliably predict motion plans or trajectories for inputs the network was not trained with (generalize to unknown cases). All this described training in said background task or background process runs in parallel to a production scenario of the robot device and thus, does not affect the performance of the conventional motion planner.

Once the learning-based motion planner has reached a specified level of performance quality (e.g. reliability etc.) by using the results generated by said background task, it can be employed according to the present invention in two ways: First, and according to FIG. 3, the second learning-based motion planner is directly used to produce a motion plan or a trajectory for the robot device. There are two main reasons for using the output of the conventional (two-step) motion planner instead of the output of the second learning-based motion planner: First, the trajectory produced by the second learning-based motion planner is invalid in the sense of violating at least one constraint. Second, the trajectory produced by the second learning-based motion planner is valid (in the sense of not violating any constraints) but is of lower quality (in the sense of scoring lower in terms of the specified optimization criterion). This case may be quite unlikely but cannot be excluded for sure.

Before feeding the obtained trajectories to subsequent stages in the optimization process, the trajectories are validated by checking a defined constraint satisfaction, e.g. position, speed, torque, collisions of the robot device. If the trajectories are found to be invalid, the trajectory of the conventional motion planner is only used as a fallback solution.

Second, and according to FIG. 4, the result of the second learning-based motion planner is used to warm-start, i.e., provide a good initial start value or guess for, the optimal motion planner. Warm starting the optimal motion planner (=integrated path and trajectory optimizer) in this way, can reduce computation times substantially, such that chances of concluding planning within the fixed time budget become more probable. However, in case motion planning can still not be completed in a fixed or defined time window, the solution produced by the conventional motion planner is available as a fallback solution for the robot device.

In this way, a certain quality level during production or operation of the robot device can be guaranteed. By using the method of the present invention, in the worst case, the performance of the robot device will be the same as when using the conventional motion planner alone.

In conclusion, the present invention combines different motion planning approaches to achieve a defined performance. The term “performance” can refer to different criteria, e.g. a cycle time/picks-per-hour, energy consumption, robot lifetime etc. The conventional 2-step motion planning approach results in decent performance from the very first start-up, with performance being constant over time. Pure learning-based motion planning approaches as reported in academic literature can potentially outperform conventional motion planning. However, from an industrial perspective, they come with two severe drawbacks: First, productivity at startup is zero as the system first has to learn/train a lot before starting to do anything useful. While this could be alleviated by offline pre-training, the second drawback is that there are no guarantees on performance. The system performance can be high after a long time of training—or not. The proposed adaptive runtime motion learning concept of the present invention combining all three motion planning approaches is guaranteed to never be worse than the conventional motion planner 2-step approach. Once enough data has been gathered for the learning-based motion planner to help outperforming the conventional motion planning approach (potentially in combination with the integrated path and trajectory optimizer), performance will start increasing.

When using the method of the present invention as described before, a further advantage is that the learning-based motion planner can be pre-trained in an offline phase. Additionally, transferring learning experience between different robots of the same type is possible in an efficient and cost-saving way. The present invention can be applied in an advantageous way to a robot device that performs repetitive or cyclic tasks.

According to an example, the background process is a process that is performed in parallel or in an asynchronous manner during the method steps of generating the trajectories. The background process may be performed e.g. in a cloud and/or on an additional or different computer or processing device compared to computer or processing device performing the steps of generating a first trajectory and a second trajectory. The advantage achieved is that generating the trajectories is more efficient, as calculating resources used by the robot device for the generation of the trajectories are not affected. Further, using the background process or task allows efficient use of system resources.

According to an example, the method is performed in runtime and during employment of the at least one robot device. The advantage achieved is that the performance of the robot device can be improved efficiently during employment without the need of having idle times to reconfigure the at least one robot device.

According to an example, the post-process comprises the step of validating the second trajectory is performed by comparing a first quality parameter of the second trajectory with a defined second quality parameter and if the first quality parameter fulfils the second quality parameter, proceed with step of comparing the first trajectory with the optimized second trajectory.

According to an example, the second quality parameter defines at least one criterion relating to a property of the at least one robot device. The advantage achieved is that the performance of the at least one robot device can be efficiently improved and adapted to changing applications and production conditions.

According to an example, the post-process comprises the step of optimizing the second trajectory by using as an initial solution for the optimal motion planner to generate an optimized second trajectory. The advantage achieved is that an optimized output for the learning-based motion planer can be achieved faster and in a more efficient way.

According to an example, the at least one query parameter comprises a start and a target information for the at least one robot device. The advantage achieved is an efficient and streamlined optimization of the output trajectory according to specified production requirements or conditions.

According to an example, the first learning-based motion planner and the second learning-based motion planner comprise an artificial neuronal network. The advantage achieved is an efficient generation of a trajectory for the at least one robot device.

According to an example, the first learning-based motion planner is pre-trained in a pre-training process by performing the background process at least partly offline. The advantage achieved is that the at least one robot device can be trained in an efficient manner and thus, be used for production in a faster way without a large downtime of the at least one robot device.

According to an example, a step of transfer learning is provided, wherein the optimized second trajectory is used as a starting point for training a second robot device. The advantage achieved is that multiple robot devices can be trained in parallel and faster, so the robot devices can be used faster in a production environment, reducing costs due to downtime caused by configuration processes of the robot devices.

In a second aspect of the present invention, a computer is provided comprising a processor configured to perform the method of the preceding aspect.

In a third aspect of the present invention, there is provided a computer program product comprising instructions which, when the program is executed by a computer processor, causes the computer to perform the method of any of the first and second aspects.

In a fourth aspect of the present invention, a machine-readable data medium and/or download product containing the computer program of the third aspect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE SIGNS

100 Method
102 Generating
104 Generating
106 Comparing
108 Performing
111 Background task/process
112 Feeding
114 Training
118 Selecting
119 Validating
120 Transfer learning
122 Pre-training
124 Post process
10, 20 Robot device
30 First trajectory
32 Second trajectory
34 Optimized second trajectory
36 Query parameter
40 Conventional motion planner
50 First learning-based motion planner
51 Second learning-based motion planner
60 Optimal motion planner
63 Validator
65 Output
68 Parameter
70 Database
80 Training data
82 First quality parameter
84 Second quality parameter

What is claimed is:

1. A method for an optimized motion planning of at least one robot device, comprising:
generating a first trajectory for the at least one robot device based on at least one query parameter by using a conventional motion planner that is configured to plan a geometric path in a first step and optimize an evolution over time on the geometric path in a second step in order generate the first trajectory;
generating a second trajectory by using a learning-based motion planner;
applying a post process to validate an optimized second trajectory based on the second trajectory;
comparing the first trajectory with the optimized second trajectory based on at least one performance criterion and selecting the trajectory that better meets the at least one performance criterion; and
performing a background process to improve the learning-based motion planner, the background process comprising:
feeding an optimal motion planner that integrates path and trajectory generation with the at least one query parameter to generate training data; and
training the first learning-based motion planner by using the training data;
wherein at least one parameter of the first learning-based motion planner is used as an input parameter for the second learning-based motion planner.

2. The method according to claim 1, wherein the background process is a process that is performed in parallel or in an asynchronous manner during the method steps of generating the trajectories.

3. The method according to claim 1, wherein the method is performed in runtime and during employment of the at least one robot device.

4. The method according to claim 1, wherein the post-process comprises the step of validating the second trajectory by comparing a first quality parameter of the second trajectory with a defined second quality parameter and when the first quality parameter fulfils the second quality parameter, proceed with step of comparing.

5. The method according to claim 4, wherein the second quality parameter defines at least one criterion relating to a property of the at least one robot device.

6. The method according to claim 1, wherein the post-process comprises the step of optimizing the second trajectory by using it as an initial solution for the optimal motion planner to generate an optimized second trajectory.

7. The method according to claim 1, wherein the at least one query parameter comprises a start and a target information for the at least one robot device.

8. The method according to claim 1, wherein the first learning-based motion planner and the second learning-based motion planner comprises an artificial neuronal network.

9. The method according to claim 1, wherein the first learning-based motion planner is pre-trained in a pre-training process by performing the background process at least partly offline.

10. The method according to claim 1, wherein the optimized second trajectory is used as a starting point for training a second robot device.

11. A computer program comprising computer executable instructions stored in tangible computer storage media, wherein the computer executable instructions are configured to be executed by a computer and to carry out a method for generating an optimized motion planning of at least one robot device, comprising:
instructions for generating a first trajectory for the at least one robot device based on at least one query parameter by using a conventional motion planner that is configured to plan a geometric path in a first step and optimize an evolution over time on the geometric path in a second step in order generate the first trajectory;
instructions for generating a second trajectory by using a learning-based motion planner;
instructions for applying a post process to validate an optimized second trajectory based on the second trajectory;
instructions for comparing the first trajectory with the optimized second trajectory based on at least one performance criterion and selecting the trajectory that better meets the at least one performance criterion; and
instructions for performing a background process to improve the learning-based motion planner, the background process comprising:
feeding an optimal motion planner that integrates path and trajectory generation with the at least one query parameter to generate training data; and
training the first learning-based motion planner by using the training data;
wherein at least one parameter of the first learning-based motion planner is used as an input parameter for the second learning-based motion planner.

12. The computer program of claim 11, wherein the background process is a process that is performed in parallel or in an asynchronous manner during the method steps of generating the trajectories.

13. The computer program of claim 11, wherein the method is performed in runtime and during employment of the at least one robot device.

14. The computer program of claim 11, wherein the post-process comprises instructions for validating the second trajectory by comparing a first quality parameter of the second trajectory with a defined second quality parameter and when the first quality parameter fulfils the second quality parameter, proceed with the instructions for comparing.

15. The computer program of claim 14, wherein the second quality parameter defines at least one criterion relating to a property of the at least one robot device.

16. The computer program of claim 11, wherein the post-process comprises instructions for optimizing the second trajectory by using it as an initial solution for the optimal motion planner to generate an optimized second trajectory.

17. The computer program of claim 11, wherein the at least one query parameter comprises a start and a target information for the at least one robot device.

18. The computer program of claim 11, wherein the first learning-based motion planner and the second learning-based motion planner comprises an artificial neuronal network.

19. The computer program of claim 11, wherein the first learning-based motion planner is pre-trained in a pre-training process by performing the background process at least partly offline.

20. The computer program of claim 11, wherein the optimized second trajectory is used as a starting point for training a second robot device.
